(19) United States
(12) Patent Application Publication
(10) Pub. No.: US 2004/0161028 A1
(43) Pub. Date: Aug. 19, 2004

(54) Method and apparatus for use in DSP-based testing

(76) Inventors: Gordon Roberts, Montreal West (CA); Chris Taillefer, Montreal (CA)

Correspondence Address: SMART & BIGGAR/FETHERSTONHAUGH, 1000 de la GAUCHETIERE WEST, SUITE 3400, MONTREAL, QC, H3B 4W5, CA

(21) Appl. No.: 10/777,094

(22) Filed: Feb. 13, 2004

Related U.S. Application Data
(60) Provisional application No. 60/447,024, filed on Feb. 13, 2003.
(60) Provisional application No. 60/492,731, filed on Aug. 6, 2003.

(51) Int. Cl. H04Q 1/20

(52) U.S. Cl. 375/227

(57) ABSTRACT

An apparatus suitable for use in identifying a noise component originating from a certain source of noise in a DSP-based mixed-signal system is provided. The apparatus includes a processing unit which receives a first signal released by a first signal path, the first signal path including a digital-to-analog converter and a first analog-to-digital converter. The processing unit also receives a second signal released by a second signal path, the second signal path including the digital-to-analog converter and a second analog-to-digital converter. The first signal and the second signal are processed to derive a noise component associated to a certain source of noise, the certain source of noise being a selected one of the digital-to-analog converter, the first analog-to-digital converter and the second analog-to-digital converter. A signal indicative of the noise component associated to the certain source of noise is then released.

### CROSS-REFERENCE TO RELATED APPLICATIONS

The present application claims priority from U.S. provisional application serial No. 60/447,024 filed Feb. 13, 2003 and U.S. provisional application serial No. 60/492,731 filed Aug. 6, 2003. The contents of the above documents are incorporated herein by reference.

### FIELD OF THE INVENTION

The present invention relates generally to electronic chips and devices, and more particularly, to a method and apparatus suitable for use in performing noise measurements on an analog or mixed-signal device using a DSP-based test system.

### BACKGROUND OF THE INVENTION

DSP-based test systems are commonly used for characterising arbitrary mixed-signal devices (called the devices-under-test or DUTs). In such systems, a mixed-signal test path will typically include a digital-to-analog converter (DAC) and an analog-to-digital converter (ADC). As a result, measurements of the noise properties of the DUT will be affected by the presence of the test equipment due in part to the presence of the DAC and the ADC in the signal path. In addition, clock jitter effects in a DSP-based mixed-signal test system severely limit its measurement accuracy.

In the context of the above, there is a need in the industry to provide a method and system for use in performing noise measurements using a DSP-based test system that alleviates at least in part problems associated with the existing systems and methods.

### SUMMARY OF THE INVENTION

In accordance with a broad aspect, the invention provides a method for identifying a noise component originating from a certain source of noise in a DSP-based mixed-signal system. The method includes receiving a first signal released by a first signal path, the first signal path including a digital-to-analog converter and a first analog-to-digital converter. The method also includes receiving a second signal released by a second signal path, the second signal path including the digital-to-analog converter and a second analog-to-digital converter. The first signal and the second signal are processed to derive a noise component associated to a certain source of noise, where the certain source of noise is a selected one of the digital-to-analog converter, the first analog-to-digital converter and the second analog-to-digital converter. A signal indicative of the noise component associated to the certain source of noise is then released.

In accordance with another broad aspect, the invention provides a method for identifying a noise component originating from a certain source of noise in a DSP-based mixed-signal system. The method comprises receiving a first signal released by a first signal path, the first signal path including a digital-to-analog converter and a first analog-to-digital converter. The method also includes receiving a second signal released by a second signal path, the second signal path including the digital-to-analog converter and a second analog-to-digital converter. The method also includes processing the first signal to derive a first frequency domain signal and processing the first frequency domain signal to derive a first noise component associated with the first signal. The method also includes processing the second signal to derive a second frequency domain signal and processing the second frequency domain signal to derive a second noise component associated with the second signal. The method also includes processing the first frequency domain signal and the second frequency domain signal to derive a third noise component. The third noise component is indicative of a noise component associated with a certain source of noise, the certain source of noise being a selected one of the digital-to-analog converter, the first analog-to-digital converter and the second analog-to-digital converter. The method also includes releasing a signal indicative of the noise component associated to the certain source of noise.

Advantageously, by converting the first signal and the second signal into the frequency domain, systematic error such as gain and DC offset can be removed from the error component. Another advantage of converting the first signal and the second signal into the frequency domain is that systematic error can be removed from the error component using a one period of the input signal.

In accordance with a specific implementation, the noise component associated to the certain source of noise is indicative of an average noise power of the certain source of noise. In accordance with a non-limiting implementation, the noise component associated to the certain source of noise includes either one of jitter induced noise, thermal induced noise, quantization noise or a combination of at least two of jitter induced noise, thermal induced noise and quantization noise. In accordance with another non-limiting implementation, the noise component associated to the certain source of noise excludes jitter-induced noise.

In accordance with a specific implementation, the first noise component and the second noise component are indicative of average noise powers associated with the first signal and the second signal respectively. A third noise component is then generated at least in part on the basis of a combination of the first signal and the second signal. The third noise component is indicative of an average noise power associated to a combination of the first signal and the second signal.

In accordance with a specific example of implementation, the noise component associated to the certain source of noise is processed on the basis of a signal applied to the first signal path and to the second signal path to derived a transmission parameter data element associated to the certain source of noise.

In accordance with another broad aspect, the invention provides an apparatus for identifying a noise component originating from a certain source of noise in a DSP-based mixed-signal system in accordance with the above-described method.

In accordance with yet another broad aspect, the invention provides a computer readable medium including a program element suitable for execution by a computing apparatus for identifying a noise component originating from a certain source of noise in a DSP-based mixed-signal system in accordance with the above described method.

In accordance with a broad aspect, the invention provides a system suitable use in identifying a noise component originating from a source of noise in a DSP-based mixed-signal system. The system includes a test module and a processing unit. The test module includes an input suitable for receiving a test signal, a first output suitable for releasing a first signal and a second output for releasing a second signal. A first signal path is between the input and the first output and includes a digital-to-analog converter and a first analog-to-digital converter. A second signal path is between the input and the second output and includes the same digital-to-analog converter as in the first path and a second analog-to-digital converter. The processing unit processes the first signal and the second signal to derive a noise component associated to a certain source of noise. The certain source of noise is a selected one of the digital-to-analog converter, the first analog-to-digital converter and the second analog-to-digital converter. The noise component associated to the certain source of noise is then released at an output.

In accordance with another broad aspect, the invention provides a method suitable for deriving a transmission parameter associated to a device in a DSP-based mixed-signal system. The method includes receiving a first signal released by a first signal path, the first signal path including a digital-to-analog converter and a first analog-to-digital converter. The method also includes receiving a second signal released by a second signal path, the second signal path including the digital-to-analog converter and a second analog-to-digital converter. The method also includes receiving a third signal derived from a test signal applied to the first signal path and to the second signal path. The first signal and the second signal are processed to derive a noise component associated to a certain device, the certain device being a selected one of the digital-to-analog converter, the first analog-to-digital converter and the second analog-to-digital converter. A transmission parameter data element associated to the certain device is then derived at least in part on the basis of the noise component associated to the certain device and the third signal. A signal indicative of the transmission parameter data element associated to the certain device is then released.

In accordance with a specific implementation, the transmission parameter may be any of a signal-to-noise ratio (SNR), signal-to-noise-and-distortion ratio (SNDR or SINAD), total-harmonic distortion (THD), spurious free dynamic range (SFDR), etc.

In accordance with another broad aspect, the invention provides an apparatus for deriving a transmission parameter associated to a device in a DSP-based mixed-signal system in accordance with the above-described method.

In accordance with yet another broad aspect, the invention provides a computer readable medium including a program element suitable for execution by a computing apparatus for deriving a transmission parameter associated to a device in a DSP-based mixed-signal system in accordance with the above described method.

In accordance with another broad aspect, the invention provides a system suitable use in deriving a transmission parameter associated to a device in a DSP-based mixed-signal system. The system includes a test module and a processing unit. The test module includes an input suitable for receiving a test signal, a first output suitable for releasing first signal and a second output for releasing a second signal. The test module also includes a first signal path between the input and the first output including a digital-to-analog converter and a first analog-to-digital converter as well as a second signal path between the input and the second output including the digital-to-analog converter and a second analog-to-digital converter. The processing unit processes the first signal and the second signal to derive a noise component associated to a certain device. The certain device is any one of the digital-to-analog converter, the first analog-to-digital converter and the second analog-to-digital converter. The processing unit then derives a transmission parameter data element associated to the certain device at least in part on the basis of the noise component associated to a certain device and the test signal received at the input of the test module. The data element indicative of the transmission parameter associated to the certain device is then released at an output.

In accordance with another aspect, the invention provides an apparatus suitable for use in identifying a noise component originating from a device-under-test in a DSP-based mixed-signal system. The apparatus includes a processing unit which receives a first signal released by a first signal path, the first signal path including a digital-to-analog converter and a first analog-to-digital converter. The processing unit also receives a second signal released by a second signal path including the digital-to-analog converter and a second analog-to-digital converter. The processing unit also receives a third signal released by a third signal path including the digital-to-analog converter and a device-under-test. The first signal, the second signal and the third signal are processed to derive a noise component associated to the device-under-test. A signal indicative of the noise component associated to the device-under-test is released at an output.

In a non-limiting implementation, the device-under-test is a third analog-to-digital converter. In accordance with another non-limiting implementation, the device-under-test may be any other mixed signal device.

In accordance with another broad aspect, the invention provides a system suitable use in identifying a noise component originating from a device-under-test in a DSP-based mixed-signal system. The system includes a test module including an input suitable for receiving a test signal, a first output suitable for releasing a first signal, a second output for releasing a second signal and a third output for releasing a third signal. A first signal path is between the input and the first output and includes a digital-to-analog converter and a first analog-to-digital converter. A second signal path is between the input and the second output and includes the digital-to-analog converter and a second analog-to-digital converter. A third signal path is between the input and the third output and includes the digital-to-analog converter and a device-under-test. The system also includes a processing unit adapted for processing the first signal, the second signal and the third signal to derive a noise component associated to the device-under-test. The noise component associated to the device-under-test is then released at an output.

In a non-limiting implementation, the device-under-test is a third analog-to-digital converter. In accordance with another non-limiting implementation, the device-under-test may be any other mixed signal device.

In accordance with another broad aspect, the invention provides an apparatus suitable for use in identifying a noise component originating from a certain source of noise in a DSP-based mixed-signal system. The apparatus includes a processing unit operative for receiving a first signal released by a first signal path including a primary component and a secondary component. The processing unit is also adapted for receiving a second signal released by a second signal path including the primary component and a third component distinct from the secondary component. The processing unit processes the first signal and the second signal to derive a noise component associated to a certain source of noise, the certain source of noise being a selected one of the primary component, the secondary component and the third component. A signal indicative of the noise component associated to the certain source of noise is released at the output.

In a specific implementation, the primary component is a digital-to-analog converter and the secondary component is a first analog-to-digital converter and the third component is a second analog-to-digital converter.

In another specific implementation, the primary component is an analog-to-digital converter and the second component is a first digital-to-analog converter and the third component is a second digital-to-analog converter.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a block diagram of a general configuration of a DSP-based channel test system in accordance with a non-limiting implementation of the invention;

FIG. 2 is a functional block diagram illustrating a non-limiting example of a noise model for a DAC-ADC combination in a DSP-based channel testing system;

FIG. 3 is a functional block diagram showing components of a system for isolating the noise components in the DSP-based channel testing system in accordance with a non-limiting implementation of the invention;

FIG. 4 is a functional block diagram illustrating a noise model for the system shown in FIG. 3;

FIG. 5 is a block diagram of a first configuration of the system for isolating a first noise component in the DSP-based channel testing system in accordance with a non-limiting implementation of the invention;

FIG. 6 is a block diagram of a second configuration of the system for isolating a second noise component in the DSP-based channel testing system in accordance with a non-limiting implementation of the invention;

FIG. 7 is a block diagram of a third configuration of the system for isolating a third noise component in the DSP-based channel testing system in accordance with a non-limiting implementation of the invention;

FIG. 8 is a block diagram of an apparatus suitable for implementing a process for isolating noise components in the DSP-based channel testing system in accordance with a non-limiting implementation of the invention.

Other aspects and features of the present invention will become apparent to those ordinarily skilled in the art upon review of the following description of specific embodiments of the invention in conjunction with the accompanying figures.

### DETAILED DESCRIPTION

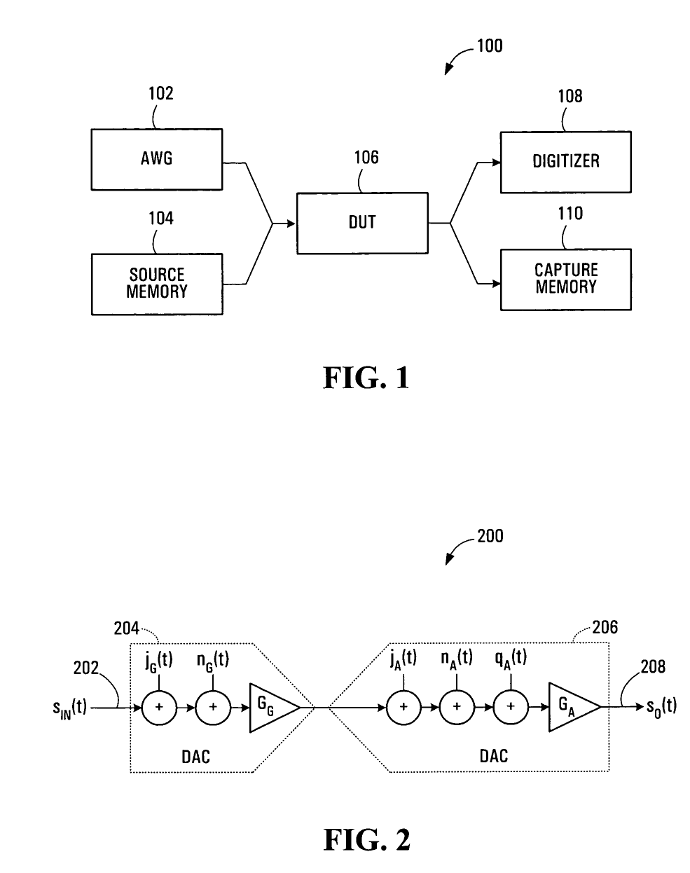

With reference to FIG. 1, there is shown a general configuration of a system 100 suitable for use in performing noise measurements on a device under test 106 in accordance with a specific implementation.

Such a test system 100 typically includes an arbitrary analog waveform generator (AWG) 102, a source memory (SMEM) 104 for exciting the digital port of a mixed-signal device, a digitizer (DIG) 108 that samples an analog waveform, and a capture memory (CMEM) 110 for collecting digital data from a digital output port.

Without loss of generality, there are four possible signal paths involving the four components of the DSP-based test system 100: (i) AWG 102-DUT 106-DIG 108, (ii) AWG 102-DUT 106-CMEM 110, (iii) SMEM 104-DUT 106-DIG 108, and (iv) SMEM 104-DUT 106-CMEM 110.

Regardless of the test configuration, a mixed-signal test path will typically include a digital-to-analog (DAC) and an analog-to-digital converter (ADC) in its signal path. As a result, measurements taken and stored in the CMEM 110 and the DIG 108 will include noise from the device under test 106 as well as the DAC and the ADC in the signal path. Consequently, an analysis of the noise properties of a DAC-ADC combination is sufficient to cover all four possible test configurations so that the noise of the DUT can be determined more precisely. If the DUT is a DAC, then analysis of the DAC-ADC will give us a measure of the DAC performance by removing the ADC noise measurement. If the DUT is an ADC, the analysis of the DAC-ADC will give us a measure of the ADC performance by removing the DAC noise measurement. If the DUT is neither a DAC nor a ADC, then an analysis of the DAC-ADC will be used to remove the DAC and ADC noise measurement from the DAC-DUT-ADC measurement.

For the purpose of simplicity, the following description will describe the analysis of the noise properties of a DAC-ADC combination. It will be readily apparent to a person skilled in the art in light of this specification that mixed signal paths including components other than the DAC-ADC combination can also be analysed in light of the methods presented in this specification.

FIG. 2 shows a non-limiting example of a model for the noise properties of a DSP-based test system 200 with a DAC-ADC combination in accordance with a non-limiting illustration. The input and output signals of the DAC 204-ADC 206 combination are denoted s_{IN}(t) 202 and s_{O}(t) 208, respectively. The gains of the DAC 204 and ADC 206 are denoted G_{G} and G_{A}, respectively. In addition, the DAC 204 and ADC 206 will contribute both thermal noise (n_{G}(t) and n_{A}(t)) and jitter-induced noise j_{G}(t) and j_{A}(t)).

The ADC 206 also introduces a quantization noise component, denoted q_{A}(t) as shown in FIG. 2. Mathematically, the power spectral density (PSD) of the output signal 208 may be written in terms of the PSD of the various inputs as follows:

Sₒ(ω)=|G_{A}(ω)|²(S_{JA}(ω)+S_{NA}(ω)+S_{QA}(ω))+|G_{G}(ω)G_{A}(ω)|²(S_{JG}(ω)+S_{NG}(ω)+S_{IN}(ω)). (1)

The average power of the test system output can be expressed as follow:

σ_{O}²=σ_{IN}²+σ_{JA}²+σ_{NA}²+σ_{QA}²+σ_{JG}²+σ_{NG}², (2)

where the individual terms can be derived from the following:

$$\begin{matrix}{σ}_{QA}^{2} \approx \frac{{V}_{LSB}^{2}}{12} , & ( 3 ) \\ {σ}_{IN}^{2} = \frac{1}{2 π} {\int }_{0}^{{F}_{s}} {\vert {G}_{A} ( ω ) {G}_{G} ( ω ) \vert }^{2} {S}_{IN} ( ω ) ⅆ ω , & ( 4 ) \\ {σ}_{JA}^{2} = \frac{1}{2 π} {\int }_{0}^{{F}_{s}} {\vert {G}_{A} ( ω ) \vert }^{2} {S}_{JA} ( ω ) ⅆ ω , & ( 5 )\end{matrix}$$

where Fₛ is the sampling frequency of the ADC and DAC 206.

The remaining terms have a form very similar to that in equations (3) and (4) and therefore will not be shown here as there derivation will be readily apparent to the person skilled in the art in light of this specification.

Generally speaking, the signal-to-noise ratio (SNR) of the test system output 208 is the ratio of the signal bin power of the signal applied to input 202 to the sum of all the non-harmonically related bin powers obtained from the PSD of the signal at output 208. Mathematically, the SNR can be represented by:

$$SNR = \frac{{σ}_{IN}^{2}}{{σ}_{JA}^{2} + {σ}_{NA}^{2} + {σ}_{QA}^{2} + {σ}_{JG}^{2} + {σ}_{NG}^{2}} . \qquad ( 6 )$$

The SNR measurement in equations 6 includes the noise from the DAC 206 and the ADC 206, as well as two jitter-induced noise components j_{G}(t) and j_{A}(t).

It is desirable that, when the device-under-test (DUT) is a digital-to-analog converter (DAC), the SNR include the thermal-induced noise of the DAC, namely be:

$${SNR}_{DAC} = \frac{{σ}_{IN}^{2}}{{σ}_{NG}^{2}} . \qquad ( 7 )$$

Conversely, when the DUT is an ADC, the SNR metric should be based on the following,

$${SNR}_{ADC} = \frac{{σ}_{IN}^{2}}{{σ}_{NA}^{2} + {σ}_{QA}^{2}} . \qquad ( 8 )$$

The terms σ_{NA}², σ_{QA}² and σ_{NG}² cannot be readily measured. In accordance with a broad aspect, the invention provides an apparatus and method for use in identifying a noise component originating from a certain source of noise in a DSP-based mixed-signal system. For the purpose of illustration, the present specification presents a method for isolating the various noise components from a noise measurement thus enabling a more accurate SNR calculation, or the calculation of other transmission parameters, for a DAC, ADC or any other arbitrary DUT.

2. The Double-ADC Method/System

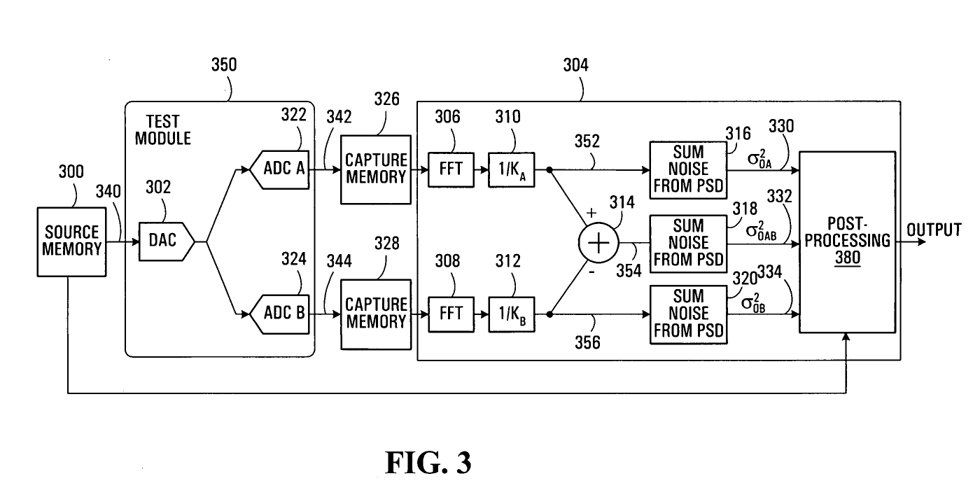

A specific example of a system for identifying a noise component originating from a certain source of noise in a DSP-based mixed-signal system is shown in FIG. 3.

The system includes a test module 350, a processing unit 304, a signal source 300 and memory units 236 and 328.

The test module 350 includes an input 340 coupled to signal source 300, a DAC 302, a first ADC “A” 322, a second ADC “B” 324, a first output 342 coupled to memory unit 326 and a second output 344 coupled to memory 328. The test module 350 includes a first signal path between the input 340 and the first output 342 wherein the first signal path includes DAC 302 and ADC “A” 322. The test module 350 includes a second signal path between the input 340 and the second output 344 wherein the second signal path includes DAC 302 and ADC “B” 328. In a specific implementation, both ADCs 322 sample the output of the DAC 302 at the same time. In use, a test signal originating from the signal source 300 is applied to the input 340 of the test module 350. The test signal travels along the first signal path and the resulting output signal is stored in the memory unit 326. The test signal also travels along the second signal path and the resulting output signal is stored in the memory unit 328.

The processing unit 304 receives the signal from memory unit 326 and the signal from memory unit 328 and processes these signals to derive a noise component associated to a certain source of noise. The certain source of noise is a selected one of the digital-to-analog converter (DAC) 302, the first analog-to-digital converter (ADC “A”) 322 and the second analog-to-digital converter (ADC “B”) 324.

The process implemented by the processing unit 304 is substantially similar whether the DUT is the DAC 302, ADC 322 or ADC 324 and is described herein below.

In a specific implementation, the processing unit 304 is adapted to generate a first noise component 330 at least in part on the basis of the signal released at output 342 of the test module 350, herein referred to as the first signal. The first noise component 330 is indicative of an average noise power associated with the first signal. The processing unit 304 also generates a second noise component 332 at least in part on the basis of the signal released at output 344 of the test module 350, herein referred to as the second signal. The second noise component 334 is indicative of an average noise power associated with the second signal. The processing unit also generates a third noise component 332 at least in part on the basis of a combination of the signals released from the first and second paths of the test module 350. The third noise component is indicative of an average noise power associated to a difference between the first signal and the second signal. The first noise component 330, the second noise component 334 and the third noise component 332 are then processed to derive the noise component associated to the certain source of noise.

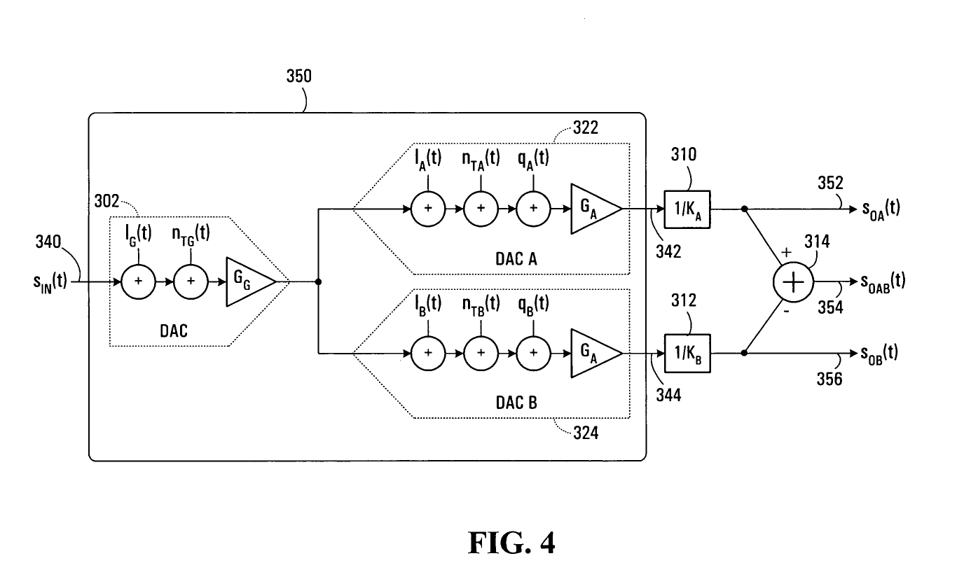

As shown FIG. 3, the processing unit 304 includes a first FFT unit 306, a second FFT unit 308, a first normalisation module 310, a second normalisation module 312, a difference module 314, a first power-spectral density summing unit 316, a second power-spectral density summing unit 320, a third power-spectral density summing unit 318 and a post-processing unit 380. FIG. 4 shows a noise model for the system of FIG. 3.

The first FFT unit 306 applies a fast Fourrier transform (FFT) on the first signal to derive a first FFT signal. The first FFT signal is then normalised by first normalisation module 310 to obtain a first normalised FFT signal 352. In a non-limiting implementation, the normalisation factor for the first normalisation module 310, K_{A}=G_{A}(ω_{IN})G_{G}(ω_{IN}), is obtained by calculating the ratio of the first signal amplitude (released at output 342) to the test signal amplitude (applied to input 340) when the test signal frequency is ω_{IN}. The first normalised FFT signal 352 is processed by the first power-spectral density summing unit 316 to derive the average noise power associated with the first signal which is released as the first noise component 330.

The second FFT unit 308 applies a fast Fourrier transform (FFT) on the second signal to derive a second FFT signal. The second FFT signal is then normalised by second normalisation module 312 to obtain a second normalised FFT signal 356. The normalisation factor for the second normalisation module 312, K_{B}=G_{B}(ω_{IN})G_{G}(ω_{IN}), is obtained by calculating the ratio of the second signal amplitude (released at output 344) to the test signal amplitude (applied to input 340) when the test signal frequency is ω_{IN}. The second normalised FFT signal 356 is processed by the second power-spectral density summing unit 320 to derive the average noise power associated with the second signal which is released as the second noise component 334.

The difference module 314 applies a subtraction operation on first normalised FFT signal 352 and the second normalised FFT signal 356 to derive a difference signal 354. The difference signal 354 is then processed by the third power-spectral density summing unit 320 to derive the average noise power associated with a combination of the first signal and the second signal which is released as the third noise component 332.

Detailed analysis (which accounts for the correlated DAC input) reveals that the power spectral density (PSD) of the signals denoted 352 354 356 are as follows:

$$\begin{matrix}\begin{matrix}{S}_{OA} ( ω ) = {\vert \frac{{G}_{A} ( ω )}{{K}_{A}} \vert}^{2} ( {S}_{JA} ( ω ) + {S}_{NA} ( ω ) + {S}_{QA} ( ω ) ) + \\ {\vert \frac{{G}_{G} ( ω ) {G}_{A} ( ω )}{{K}_{A}} \vert}^{2} ( {S}_{JG} ( ω ) + {S}_{NG} ( ω ) + {S}_{IN} ( ω ) ) ,\end{matrix} & \begin{matrix}\begin{matrix}( 9 ) \\ for\end{matrix} \\ 352\end{matrix} \\ \begin{matrix}{S}_{OB} ( ω ) = {\vert \frac{{G}_{B} ( ω )}{{K}_{B}} \vert}^{2} ( {S}_{JB} ( ω ) + {S}_{NB} ( ω ) + {S}_{QB} ( ω ) ) + \\ {\vert \frac{{G}_{G} ( ω ) {G}_{B} ( ω )}{{K}_{B}} \vert}^{2} ( {S}_{JG} ( ω ) + {S}_{NG} ( ω ) + {S}_{IN} ( ω ) ) ,\end{matrix} \\ and & \begin{matrix}\begin{matrix}( 10 ) \\ for\end{matrix} \\ 356\end{matrix} \\ \begin{matrix}{S}_{OAB} ( ω ) = {\vert \frac{{G}_{A} ( ω )}{{K}_{A}} \vert}^{2} ( {S}_{JA} ( ω ) + {S}_{NA} ( ω ) + {S}_{QA} ( ω ) ) + \\ {\vert \frac{{G}_{B} ( ω )}{{K}_{B}} \vert}^{2} ( {S}_{JB} ( ω ) + {S}_{NB} ( ω ) + {S}_{QB} ( ω ) ) + \\ {\vert ( \frac{{G}_{A} ( ω )}{{K}_{A}} - \frac{{G}_{B} ( ω )}{{K}_{B}} ) \cdot {G}_{G} ( ω ) \vert}^{2} ( {S}_{JG} ( ω ) + \\ {S}_{NG} ( ω ) + {S}_{IN} ( ω ) ) .\end{matrix} & \begin{matrix}\begin{matrix}( 11 ) \\ for\end{matrix} \\ 354\end{matrix}\end{matrix}$$

Experience shows that a large mismatch in frequency response results in a small error in SNR measurement. Therefore, for the purpose of simplicity, the ADC gains GA and GB have been assumed to be frequency independent.

Using the same average power notation as in equations (3)-(5) mentioned above, the average the average noise power of the output S_{OA}(ω) released as the first noise component 330 can be expressed as:

$${σ}_{OA}^{2} = \frac{{σ}_{JA}^{2} + {σ}_{NA}^{2} + {σ}_{QA}^{2} + {σ}_{JG}^{2} + {σ}_{NG}^{2} + {σ}_{IN}^{2}}{{K}_{A}^{2}} . \qquad ( 12 )$$

Since our normalization factors are related by G_{A}/K_{A}=G_{B}/K_{B}, the average power of the output S_{OB}(ω) released as the second noise component 334 and the average power of the output S_{OAB}(ω) released as the third noise component 332 may be expressed as:

$${σ}_{OB}^{2} = \frac{{σ}_{JB}^{2} + {σ}_{NB}^{2} + {σ}_{QB}^{2} + {σ}_{JG}^{2} + {σ}_{NG}^{2} + {σ}_{IN}^{2}}{{K}_{A}^{2}} , \qquad ( 13 )$$

and

$${σ}_{OAB}^{2} = \frac{{σ}_{JA}^{2} + {σ}_{NA}^{2} + {σ}_{QA}^{2}}{{K}_{A}^{2}} + \frac{{σ}_{JB}^{2} + {σ}_{NB}^{2} + {σ}_{QB}^{2}}{{K}_{A}^{2}} . \qquad ( 14 )$$

It can be appreciated that equations (12)-(14) can be considers as a system of three simultaneous equations in three unknowns namely:

σ²_{JA}+σ²_{NA}+σ²_{QA}

σ²_{JB}+σ²_{NB}+σ²_{QB} and

σ²_{JG}+σ²_{NG}

It will be noted that σ²_{JA}+σ²_{NA}+σ²_{QA} is the average power of the noise of the ADC “A” 322, σ²_{JB}+σ²_{NB}+σ²_{QB} is the average power of the noise of the ADC “B” 324, and σ²_{JG}+σ²_{NG} is the average power of the noise of the DAC 302. Therefore by solving the above noted equations for a given one of these unknowns, the noise component associated to a either one of the DAC 302, the first ADC “A” 322 or the second ADC “B” can be determined.

Post-processing unit 380 receives the first noise component 330 σ²_{OA}, the second noise component 334 σ²_{OB} and the third noise component 332 σ²_{OAB} and processes them to derive the noise component associated to the desired source of noise. Mathematically, this can be expressed as follows:

$${σ}_{JA}^{2} + {σ}_{NA}^{2} + {σ}_{QA}^{2} = {K}_{A}^{2} \frac{{σ}_{OA}^{2} + {σ}_{OAB}^{2} - {σ}_{OB}^{2}}{2} , \qquad ( 15 )$$

and

$${σ}_{JG}^{2} + {σ}_{NG}^{2} = {K}_{A}^{2} \frac{{σ}_{OA}^{2} + {σ}_{OB}^{2} - {σ}_{OAB}^{2}}{2} . \qquad ( 16 )$$

The noise component associated to ADC “B” 324 has a form similar to that in equation (15) above and as such will not be described here.

The above has describe a specific example of a process for obtaining the average noise powers of the ADC 322 and the DAC 302 given in expressions (15) and (16).

In accordance with a variant, the post-processing unit 380 may also be adapted to further compute transmission parameters for any one of ADC 324, ADC 322 and the DAC 302. The computation of a given transmission parameter may include the jitter induced noise components (σ²_{JA}, σ²_{JB} and σ²_{JG}) or may exclude the jitter induced noise components.

The transmission parameter may be any desired transmission parameter including, but not limited to, signal-to-noise ratio (SNR), signal-to-noise-and-distortion ratio (SNDR or SINAD), total-harmonic distortion (THD) and spurious free dynamic range (SFDR). For the purpose of simplicity, the description below describes in detail the computation of the transmission parameter when the latter is a signal-to-noise ratio. The computation of the other types of parameters will become apparent to the person skilled in the art in light of this description and as such will not be described further here.

Optionally, the post-processing unit 380 may also be adapted to separate the jitter induced noise components (σ²_{JA} and σ²_{JG}) in (15) and (16). When the DUT is a DAC, the process is outlined in Section 3. The process is illustrated for the ADC case in Section 4.

3. DAC is Under Test

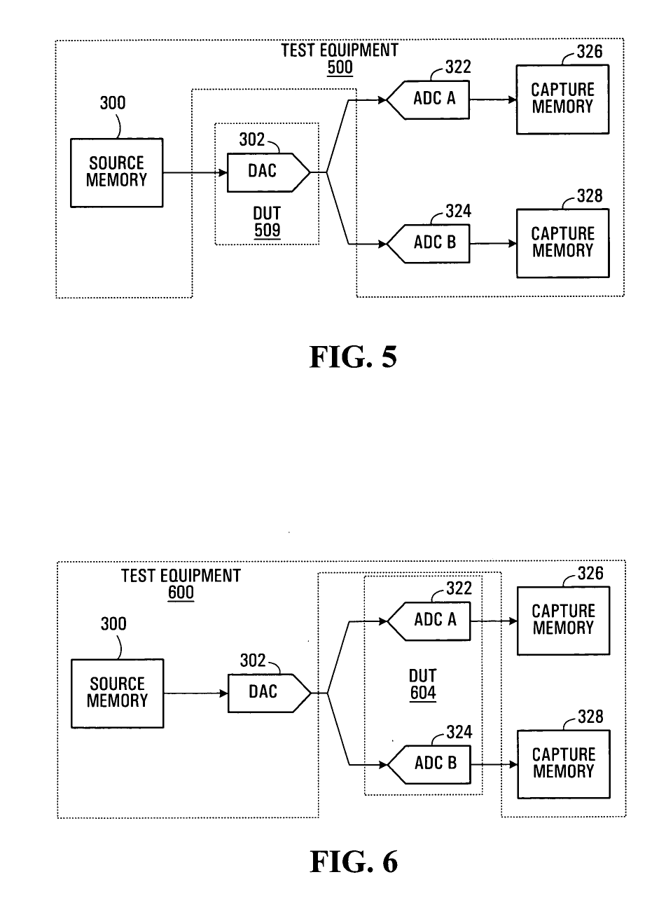

The configuration of test module 350 is shown in FIG. 5 when the DAC 302 is the DUT 509. In such a configuration, the signal source 300, the first ADC “A” 322, the second ADC “B” 324 and the memory units 326 328 are considered to from part of the testing equipment 500.

The noise generated by the test equipment 500 (i.e. the ADCs 322 and 324) can be successfully removed from the DAC 302 signal-to-noise ratio (SNR) calculation by taking the ratio of input signal bin power to the expression in equation (16) as shown in equation (17) below:

$${SNR}_{DAC} = \frac{{σ}_{IN}^{2}}{{σ}_{JG}^{2} + {σ}_{NG}^{2}} . \qquad ( 17 )$$

The jitter-induced noise power (σ²_{JG}) can be removed from the SNR measure of (17) by exploiting its frequency dependency. The average power of jitter-induced noise of a DAC may be approximated by:

$${σ}_{JG}^{2} \approx \frac{1}{2} {A}_{o}^{2} {ω}_{o}^{2} {J}_{R MS} {T}_{S} , \qquad ( 18 )$$

where A_{O} is the test signal amplitude, ω_{O} is the test signal frequency, T_{S} is the DAC's sampling period and J_{RMS} is the RMS jitter in seconds. For the purpose of simplicity, thermal noise is assumed to be white and is not dependent on the input test frequency. For more information regarding the computation of average power of jitter-induced noise, the reader is invited to refer to Mark Burns and Gordon W. Roberts, An Introduction to Mixed-Signal IC Test and Measurement, Oxford Press, pp.166-170, 2001. The content of the above document is incorporated herein by reference.

The double-ADC process described above is run twice at two different input test signal frequencies, say ω₁ and ω₂. The DAC 302 average noise power from each test, denoted NG, and N_{G2}, are obtain from equation (16) and can be expressed as follows:

N_{G1}=σ_{JG1}²+σ_{NG}² (19)

and

N_{G2}=σ_{JG2}²+σ_{NG}². (20)

The average jitter-induced noise power from the first test period (σ²_{JG1}) may be expressed in terms of the other (σ²_{JG2}) by using equation (18) as shown by the following relationship:

$${σ}_{JG1}^{2} \approx \frac{{ω}_{1}^{2}}{{ω}_{2}^{2}} {σ}_{JG2}^{2} . \qquad ( 21 )$$

The system of equations formed by (19), (20) and (21) contain three unknowns ω²_{JG1}, ω²_{JG2}, and ω²_{NG}. Solving for the average thermal noise power component yields:

$${σ}_{NG}^{2} = \frac{( {N}_{G1} ) - \frac{{ω}_{1}^{2}}{{ω}_{2}^{2}} ( {N}_{G2} )}{1 - \frac{{ω}_{1}^{2}}{{ω}_{2}^{2}}} . \qquad ( 22 )$$

The SNR of the DAC 302 under test without jitter-induced noise is obtained by dividing the output signal power to (22) as follows:

$${SNR}_{DAC} = \frac{{σ}_{IN}^{2}}{{σ}_{NG}^{2}} = \frac{{σ}_{IN}^{2} ( 1 - \frac{{ω}_{1}^{2}}{{ω}_{2}^{2}} )}{( {N}_{G1} ) - \frac{{ω}_{1}^{2}}{{ω}_{2}^{2}} ( {N}_{G2} )} , \qquad ( 23 )$$

4. ADC is Under Test

In accordance with a first specific implementation, when an ADC is the DUT, a duplicate of the ADC is used in the test module 350. This specific implementation is particularly suitable for discrete component testing.

In accordance with a second specific implementation, when an ADC is the DUT, two other ADCs are used in the test module in addition to the ADC under test. The specific implementation is particularly suitable for integrated circuit testing.

The above two examples of implementation are described herein below.

4.1 Two DUT Scenario

In accordance with a specific non-limiting example of implementation, a test module 350 as shown in FIG. 6 may be used when the ADC “A” 322 is the DUT 604 and may be duplicated by ADC “B” 324. In such a configuration, the signal source 300, the DAC 302 and the memory units 326 328 are considered to from part of the testing equipment 600.

The noise generated by the test equipment 600 (i.e. the DAC 302) can be removed by the above described process. The above described processed can then be used to derive the average power of the noise of the ADC “A” 322, namely σ²_{JA}+σ²_{NA}+σ²_{QA}, in accordance with equation (15). The SNR for the ADC “A” 322 can then be expressed as follows:

$${SNR}_{ADC} = \frac{{σ}_{IN}^{2}}{{σ}_{JA}^{2} + {σ}_{NA}^{2} + {σ}_{QA}^{2}} . \qquad ( 24 )$$

Under many testing situations the jitter induced noise power (σ²_{JA}) may not be desirable in the SNR measurement shown in equation (24).

The double-ADC process described above is run twice with two different input test signal frequencies, say ω₁ and ω₂, being applied by the source signal 300. By running the double-ADC test twice at two different test signal frequencies (ω₁ and ω₂), an SNR measurement without jitter-induced error may be obtained. The average jitter-induced noise power in an ADC may be approximated as follows:

$${σ}_{JA}^{2} \approx \frac{1}{2} {A}_{o}^{2} {ω}_{o}^{2} {J}_{R MS}^{2} \qquad ( 25 )$$

where ωₒ is the ADC input test signal frequency, A_{O} is the ADC test signal amplitude and J_{RMS} is the RMS jitter from the sampling clock. For more information regarding the computation of average power of jitter-induced noise, the reader is invited to refer to Mark Bums and Gordon W. Roberts, An Introduction to Mixed-Signal IC Test and Measurement, Oxford Press, pp.166-170, 2001. The content of the above document is incorporated herein by reference.

The average noise powers of ADC “A” are:

N_{A1}=σ_{JA1}²+σ_{NA}²σ_{QA}² (26)

and

N_{A2}=σ_{JA2}²+σ_{NA}²+σ_{QA}², (27)

where N_{G1} and N_{G2} are obtain from equation (15) while running the double-ADC test twice using two different frequencies.

A relationship between the frequency dependent jitter-induced noise components (σ²_{JA1} and σ²_{JA2}) may be acquired from equation (25) and can be expressed by:

$${σ}_{JA1}^{2} = \frac{{ω}_{1}^{2}}{{ω}_{2}^{2}} {σ}_{JA2}^{2} . \qquad ( 28 )$$

Using equations (26)-(28), the average noise power of the thermal and quantization noise can be expressed as follows:

$${σ}_{NA}^{2} + {σ}_{QA}^{2} = \frac{( {N}_{A1} ) - \frac{{ω}_{1}^{2}}{{ω}_{2}^{2}} ( {N}_{A2} )}{1 - \frac{{ω}_{1}^{2}}{{ω}_{2}^{2}}} . \qquad ( 29 )$$

Therefore, the SNR of the ADC 322 without the influence of jitter-induced noise can be calculated by dividing the input test signal average power by equation (29) producing:

$${SNR}_{ADC} = \frac{{σ}_{IN}^{2}}{{σ}_{NA}^{2} + {σ}_{QA}^{2}} = \frac{{σ}_{IN}^{2} ( 1 - \frac{{ω}_{1}^{2}}{{ω}_{2}^{2}} )}{( {N}_{A1} ) - \frac{{ω}_{1}^{2}}{{ω}_{2}^{2}} ( {N}_{A2} )} \qquad ( 30 )$$

4.2 One DUT Scenario

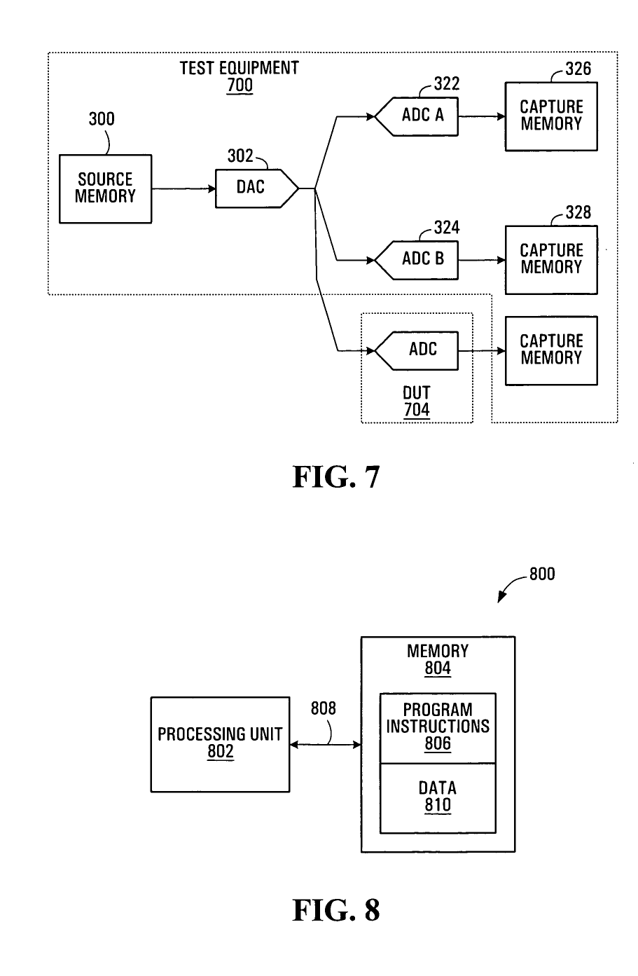

In accordance with another specific non-limiting example of implementation, a test module 350 configuration as shown in FIG. 7 may be used when an ADC is the DUT 704 and may not be duplicated. In such a configuration, the signal source 300, the DAC 302, the first ADC “A” 322, the second ADC “B” 324 and the memory units 326 328 are considered to from part of the testing equipment 700.

The double-ADC process described above is run twice with two different input test signal frequencies, say ω₁ and ω₂, being applied by the source signal 300. By running the double-ADC test twice at two different test signal frequencies (ω₁ and ω₂), an SNR measurement for the DAC 302 may be obtained according to the previously described process with reference to equation (17).

The DUT 704 is then exercised by applying the same test signal to the input of the DAC 302 and the SNR of the DUT output SNR_{OUT} incorporating the DAC 302 and ADC 704 noise is calculated. Using these two measurements, the SNR of ADC 704 under test may be obtained as follows:

$$\begin{matrix}{SNR}_{DUT} = \frac{{σ}_{IN}^{2}}{{σ}_{JDUT}^{2} + {σ}_{NDUT}^{2} + {σ}_{QDUT}^{2}} \\ = \frac{{SNR}_{DAC} \cdot {SNR}_{OUT}}{{SNR}_{DAC} - {SNR}_{OUT}} .\end{matrix} \qquad ( 31 )$$

The jitter-induced noise component may be removed from equation (31) by running the double-ADC test twice using two distinct test signal frequencies, ω₁ and ω₂. From each test the SNR metric of the DAC 302 is obtained according to equation (17). The DUT 704 is stimulated with the same two test signals and the SNR of the DUT 704 is obtained from equation (31), denoted SNR_{ADC1} and SNR_{ADC2}.

Using the property shown in equation (28), the SNR of the ADC 704 without jitter-induced noise may be expressed as:

$$\begin{matrix}{SNR}_{DUT} = \frac{{σ}_{IN}^{2}}{{σ}_{NDUT}^{2} + {σ}_{QDUT}^{2}} \\ = \frac{{SNR}_{ADC1} \cdot {SNR}_{ADC2} ( 1 - \frac{{ω}_{2}^{2}}{{ω}_{1}^{2}} )}{{SNR}_{ADC1} - \frac{{ω}_{2}^{2}}{{ω}_{1}^{2}} {SNR}_{ADC2}} .\end{matrix} \qquad ( 31 )$$

For further background information on ADC/DAC noise measurements, the reader is invited to refer to the following documents:

Robert H. Walden, Analog-to-Digital Converter Survey and Analysis, IEEE Journal on Selected Areas in Communications, Vol. 17, No. 4, April 1999.

Yves Langard, Jean-Luc Balat and Jacques Durant, An Improved Method of ADC Jitter Measurement, International Test Conference, 1994.

Philippe Cauvet and Loïc Hamonou, An Improving the Dynamic Measurements of ADC's using the 2-ADC Method, Teradyne Users Group, 2001.

The contents of the above documents are hereby incorporated by reference.

Specific Physical Implementation

Those skilled in the art should appreciate that in some embodiments of the invention, all or part of the functionality previously described herein with respect to the processing unit 304 and system may be implemented as pre-programmed hardware or firmware elements (e.g., application specific integrated circuits (ASICs), FPGA chips, ROM, PROM, EPROM, etc.), or other related components.

For example, the above described circuits may be incorporated in IC generally, diagnostic tools, IC testing equipment, on-chip testing and IC including on-chip testing functionality amongst others.

In other embodiments of the invention, all or part of the functionality previously described herein with respect to the processing unit 304 may be implemented as software consisting of a series of instructions for execution by a computing unit. The series of instructions could be stored on a medium which is fixed, tangible and readable directly by the computing unit, (e.g., removable diskette, CD-ROM, ROM, PROM, EPROM or fixed disk), or the instructions could be stored remotely but transmittable to the computing unit via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

The computing unit 800 implementing the processing unit 304 may be configured as a computing unit of the type depicted in FIG. 8, including a processor 802 and a memory 802 connected by a communication bus 808. The memory includes data 810 and program instructions 806. The processing unit 802 is adapted to process the data 810 and the program instructions 806 in order to implement the functional blocks described in the specification and depicted in the drawings. In a non-limiting implementation, the program instructions 806 implement the functionality of processing unit 304 described above.

Those skilled in the art should further appreciate that the program instructions 806 may be written in a number of programming languages for use with many computer architectures or operating systems. For example, some embodiments may be implemented in a procedural programming language (e.g., “C”) or an object oriented programming language (e.g., “C++” or “JAVA”).

Although the system has been shown as including two signal paths with respective ADCs and a common DAC, other embodiments of the present invention may include two signal paths with respective DACs and a common ADC. The identification of the noise components for the two DACs and the ADC will become apparent to the person skilled in the art in light of this specification and as such will not be described further here.

In addition, although the present description has been limited to describing the identification of the noise components associated to an ADC or a DAC, the methods described in the present specification may be use to identify noise components associated to a general mixed-signal DUT. It will be appreciated that the DUT may be an integrated circuit (IC), a discrete component or any combinations of discrete and integrated components.

In yet another embodiment of the present invention may include two signal paths with respective ADC's and a common DUT.

Although the present invention has been described in considerable detail with reference to certain preferred embodiments thereof, variations and refinements are possible without departing from the spirit of the invention. Therefore, the scope of the invention should be limited only by the appended claims and their equivalents.

1. An apparatus suitable for use in identifying a noise component originating from a certain source of noise in a DSP-based mixed-signal system, said apparatus comprising:
a. a processing unit operative for:
i. receiving a first signal released by a first signal path, the first signal path including a digital-to-analog converter and a first analog-to-digital converter;
ii. receiving a second signal released by a second signal path, the second signal path including the digital-to-analog converter and a second analog-to-digital converter;
iii. processing the first signal and the second signal to derive a noise component associated to a certain source of noise, the certain source of noise being a selected one of the digital-to-analog converter, the first analog-to-digital converter and the second analog-to-digital converter, said processing including:
1. processing said first signal to derive a first frequency domain signal;
2. processing the first frequency domain signal to derive a first noise component associated with the first signal;
3. processing said second signal to derive a second frequency domain signal;
4. processing the second frequency domain signal to derive a second noise component associated with the second signal;
5. processing the first frequency domain signal and the second frequency domain signal to derive a third noise component, the third noise component being indicative of the noise component associated with the certain source of noise;
b. an output for releasing a signal indicative of the noise component associated to the certain source of noise.

2. An apparatus as defined in claim 1, wherein said processing unit is adapted for:
i. applying a subtraction operation on the first frequency domain signal and the second frequency domain signal to derive a difference signal;
ii. processing the difference signal to derive the third noise component.

3. An apparatus as defined in claim 1, wherein the noise component associated to the certain source of noise is indicative of an average noise power of the certain source of noise.

4. An apparatus as defined in claim 1, wherein the noise component associated to the certain source of noise includes either one of:
a. jitter induced noise;
b. thermal induced noise;
c. quantization noise; or
d. a combination of at least two of jitter induced noise, thermal induced noise and quantization noise.

5. An apparatus as defined in claim 1, wherein the noise component associated to the certain source of noise excludes jitter induced noise.

6. An apparatus as defined in claim 1, wherein:
a. the first noise component is indicative of an average noise power associated with the first signal; and
b. the second noise component is indicative of an average noise power associated with the second signal.

7. An apparatus as defined in claim 6, wherein the third noise component is indicative of an average noise power associated to a difference between a signal derived from the first signal and a signal derived from a second signal.

8. An apparatus as defined in claim 1, wherein said processing unit is adapted for:
a. applying a fast fourrier transform (FFT) on said first signal to derive the first frequency domain signal;
b. applying a fast fourrier transform (FFT) on said second signal to derive the second frequency domain signal.

9. An apparatus as defined in claim 1, wherein said processing unit is further operative for processing the noise component associated to the certain source of noise on the basis of a signal applied to the first signal path and the second signal path to derived a transmission parameter data element.

10. An apparatus as defined in claim 9, wherein the transmission parameter data element is selected from the set consisting of a signal-to-noise ratio (SNR), a signal-to-noise-and-distortion ratio (SNDR or SINAD), a total-harmonic distortion (THD) and spurious free dynamic range (SFDR).

11. A method for identifying a noise component originating from a certain source of noise in a DSP-based mixed-signal system, said method comprising:
a. receiving a first signal released by a first signal path, the first signal path including a digital-to-analog converter and a first analog-to-digital converter;
b. receiving a second signal released by a second signal path, the second signal path including the digital-to-analog converter and a second analog-to-digital converter;
c. processing the first signal to, derive a first frequency domain signal;
d. processing the first frequency domain signal to derive a first noise component associated with the first signal;
e. processing the second signal to derive a second frequency domain signal;
f. processing the second frequency domain signal to derive a second noise component associated with the second signal;
g. processing the first frequency domain signal and the second frequency domain signal to derive a third noise component, the third noise component being indicative of a noise component associated with a certain source of noise, the certain source of noise being a selected one of the digital-to-analog converter, the first analog-to-digital converter and the second analog-to-digital converter;
h. releasing a signal indicative of the noise component associated to the certain source of noise.

12. A method as defined in claim 11, wherein said method comprises:
i. applying a subtraction operation on the first frequency domain signal and the second frequency domain signal to derive a difference signal;
ii. processing the difference signal to derive the third noise component.

13. A method as defined in claim 11, wherein the noise component associated to the certain source of noise is indicative of an average noise power of the certain source of noise.

14. A method as defined in claim 11, wherein the noise component associated to the certain source of noise includes either one of:
a. jitter induced noise;
b. thermal induced noise;
c. quantization noise; or
d. a combination of at least two of jitter induced noise, thermal induced noise and quantization noise.

15. A method as defined in claim 11, wherein the noise component associated to the certain source of noise excludes jitter induced noise.

16. A method as defined in claim 11, wherein:
a. the first noise component is indicative of an average noise power associated with the first signal; and
b. the second noise component is indicative of an average noise power associated with the second signal.

17. A method as defined in claim 16, wherein the third noise component is indicative of an average noise power associated to a difference between a signal derived from the first signal and a signal derived from a second signal.

18. A method as defined in claim 16, wherein said method comprises:
a. applying a fast fourrier transform (FFT) on said first signal to derive the first frequency domain signal;
b. applying a fast fourrier transform (FFT) on said second signal to derive the second frequency domain signal.

19. A method as defined in claim 11, wherein said method comprises processing the noise component associated to the certain source of noise on the basis of a signal applied to the first signal path and the second signal path to derived a transmission parameter data element.

20. A method as defined in claim 19, wherein the transmission parameter data element is selected from the set consisting of a signal-to-noise ratio (SNR), a signal-to-noise-and-distortion ratio (SNDR or SINAD), a total-harmonic distortion (THD) and spurious free dynamic range (SFDR).

21. A computer readable storage medium including a program element suitable for execution by a computing apparatus for identifying a noise component originating from a certain source of noise in a DSP-based mixed-signal system, said computer apparatus comprising:
a. a memory unit;
b. a processing operatively coupled to said memory unit, said program element when executing on said processor being operative for:
i. receiving a first signal released by a first signal path, the first signal path including a digital-to-analog converter and a first analog-to-digital converter;
ii. receiving a second signal released by a second signal path, the second signal path including the digital-to-analog converter and a second analog-to-digital converter;
iii. processing the first signal to derive a first frequency domain signal;
iv. processing the first frequency domain signal to derive a first noise component associated with the first signal;
v. processing the second signal to derive a second frequency domain signal;
vi. processing the second frequency domain signal to derive a second noise component associated with the second signal;
vii. processing the first frequency domain signal and the second frequency domain signal to derive a third noise component, the third noise component being indicative of a noise component associated with a certain source of noise, the certain source of noise being a selected one of the digital-to-analog converter, the first analog-to-digital converter and the second analog-to-digital converter;
viii. releasing a signal indicative of the noise component associated to the certain source of noise.

22. A computer readable storage medium as defined in claim 21, wherein said program element when executing on said processor is operative for:
i. applying a subtraction operation on the first frequency domain signal and the second frequency domain signal to derive a difference signal;
ii. processing the difference signal to derive the third noise component.

23. A computer readable storage medium as defined in claim 21, wherein the noise component associated to the certain source of noise is indicative of an average noise power of the certain source of noise.

24. A computer readable storage medium as defined in claim 21, wherein the noise component associated to the certain source of noise includes either one of:
a. jitter induced noise;
b. thermal induced noise;
c. quantization noise; or
d. a combination of at least two of jitter induced noise, thermal induced noise and quantization noise.

25. An apparatus as defined in claim 21, wherein the noise component associated to the certain source of noise excludes jitter induced noise.

26. A computer readable storage medium as defined in claim 21, wherein:
a. the first noise component is indicative of an average noise power associated with the first signal; and
b. the second noise component is indicative of an average noise power associated with the second signal.

27. A computer readable storage medium as defined in claim 26, wherein the third noise component is indicative of an average noise power associated to a difference between a signal derived from the first signal and a signal derived from a second signal.

28. A computer readable storage medium as defined in claim 26, wherein said program element when executing on said processor being operative for:
a. applying a fast fourrier transform (FFT) on said first signal to derive the first frequency domain signal;
b. applying a fast fourrier transform (FFT) on said second signal to derive the second frequency domain signal.

29. A computer readable storage medium as defined in claim 21, wherein said program element when executing on said processor being operative for processing the noise component associated to the certain source of noise on the basis of a signal applied to the first signal path and the second signal path to derived a transmission parameter data element.

30. A computer readable medium as defined in claim 29, wherein the transmission parameter data element is selected from the set consisting of a signal-to-noise ratio (SNR), a signal-to-noise-and-distortion ratio (SNDR or SINAD), a total-harmonic distortion (THD) and spurious free dynamic range (SFDR).

31. A system suitable use in identifying a noise component originating from a source of noise in a DSP-based mixed-signal system, said system comprising:
a. a test module including:
i. an input suitable for receiving a test signal;
ii. a first output suitable for releasing a first signal;
iii. a second output for releasing a second signal;
iv. a first signal path between said input and said first output including a digital-to-analog converter and a first analog-to-digital converter;
v. a second signal path between said input and said second output including the digital-to-analog converter and a second analog-to-digital converter;
b. a processing unit adapted for receiving the first signal and the second signal, said processing unit being operative for:
i. processing the first signal to derive a first frequency domain signal;
ii. processing the first frequency domain signal to derive a first noise component associated with the first signal;
iii. processing the second signal to derive a second frequency domain signal;
iv. processing the second frequency domain signal to derive a second noise component associated with the second signal;
v. processing the first frequency domain signal and the second frequency domain signal to derive a third noise component, the third noise component being indicative of a noise component associated with a certain source of noise, the certain source of noise being a selected one of the digital-to-analog converter, the first analog-to-digital converter and the second analog-to-digital converter;
c. an output for releasing the noise component associated to the certain source of noise.

32. A system as defined in claim 31, wherein said processing unit is operative for:
i. applying a subtraction operation on the first frequency domain signal and the second frequency domain signal to derive a difference signal;
ii. processing the difference signal to derive the third noise component.

33. A system as defined in claim 31, wherein the noise component associated to the certain source of noise is indicative of an average noise power of the certain source of noise.

34. A system as defined in claim 31, wherein the noise component associated to the certain source of noise includes either one of:
a. jitter induced noise;
b. thermal induced noise;
c. quantization noise; or
d. a combination of at least two of jitter induced noise, thermal induced noise and quantization noise.

35. A system as defined in claim 31, wherein the noise component associated to the certain source of noise excludes jitter induced noise.

36. A system as defined in claim 31, wherein:
a. the first noise component is indicative of an average noise power associated with the first signal; and
b. the second noise component is indicative of an average noise power associated with the second signal.

37. A system as defined in claim 36, wherein the third noise component is indicative of an average noise power associated to a difference between the first signal and the second signal.

38. A system as defined in claim 36, wherein said processing unit is adapted for:
a. applying a fast fourrier transform (FFT) on said first signal to the first frequency domain signal;
b. applying a fast fourrier transform (FFT) on said second signal to derive the second frequency domain signal.

39. A system as defined in claim 31, wherein said processing unit is further operative for processing the noise component associated to the certain source of noise on the basis of the test signal received at the input of said test module to derived a transmission parameter data element.

40. A system as defined in claim 39, wherein the transmission parameter data element is selected from the set consisting of a signal-to-noise ratio (SNR), a signal-to-noise-and-distortion ratio (SNDR or SINAD), a total-harmonic distortion (THD) and spurious free dynamic range (SFDR).

41. An apparatus suitable for use in deriving a transmission parameter associated to a device in a DSP-based mixed-signal system, said apparatus comprising:
a. a processing unit operative for:
i. receiving a first signal released by a first signal path, the first signal path including a digital-to-analog converter and a first analog-to-digital converter;
ii. receiving a second signal released by a second signal path, the second signal path including the digital-to-analog converter and a second analog-to-digital converter;
iii. receiving a third signal derived from a test signal applied to the first signal path and to the second signal path;
iv. processing the first signal to derive a first frequency domain signal;
v. processing the first frequency domain signal to derive a first noise component associated with the first signal;
vi. processing the second signal to derive a second frequency domain signal;
vii. processing the second frequency domain signal to derive a second noise component associated with the second signal;
viii. processing the first frequency domain signal and the second frequency domain signal to derive a third noise component, the third noise component being indicative of a noise component associated with a certain source of noise, the certain source of noise being a selected one of the digital-to-analog converter, the first analog-to-digital converter and the second analog-to-digital converter;
ix. deriving a transmission parameter data element associated to the certain device at least in part on the basis of the noise component associated to the certain device and the third signal;
b. an output for releasing a signal indicative of the transmission parameter data element associated to a certain device.

42. An apparatus as defined in claim 41, wherein said processing unit is adapted for:
i. applying a subtraction operation on the first frequency domain signal and the second frequency domain signal to derive a difference signal;
ii. processing the difference signal to derive the third noise component.

43. An apparatus as defined in claim 41, wherein the transmission parameter data element is selected from the set consisting of a signal-to-noise ratio (SNR), a signal-to-noise-and-distortion ratio (SNDR or SINAD), a total-harmonic distortion (THD) and spurious free dynamic range (SFDR).

44. An apparatus as defined in claim 41, wherein the noise component associated to the certain source of noise is indicative of an average noise power of the certain source of noise.

45. An apparatus as defined in claim 41, wherein the noise component associated to the certain source of noise includes either one of:
a. jitter induced noise;
b. thermal induced noise;
c. quantization noise; or
d. a combination of at least two of jitter induced noise, thermal induced noise and quantization noise.

46. An apparatus as defined in claim 41, wherein the noise component associated to the certain source of noise excludes jitter induced noise.

47. An apparatus as defined in claim 41, wherein:
a. the first noise component is indicative of an average noise power associated with the first signal; and
b. the second noise component is indicative of an average noise power associated with the second signal.

48. An apparatus as defined in claim 47, wherein the third noise component is indicative of an average noise power associated to a difference between a signal derived from the first signal and a signal derived from a second signal.

49. An apparatus as defined in claim 47, said processing unit being adapted for:
a. applying a fast fourrier transform (FFT) on said first signal to derive the first frequency domain signal;
b. applying a fast fourrier transform (FFT) on said second signal to the second frequency domain signal.

50. An apparatus suitable for use in identifying a noise component originating from a device-under-test in a DSP-based mixed-signal system, said apparatus comprising:
a. a processing unit operative for:
i. receiving a first signal released by a first signal path, the first signal path including a digital-to-analog converter and a first analog-to-digital converter;
ii. receiving a second signal released by a second signal path, the second signal path including the digital-to-analog converter and a second analog-to-digital converter;
iii. receiving a third signal released by a third signal path, the third signal path including the digital-to-analog converter and a device-under-test;
iv. processing the first signal, the second signal and the third signal to derive a noise component associated to the device-under-test;
b. an output for releasing a signal indicative of the noise component associated to the device-under-test.

51. An apparatus as defined in claim 50, wherein the device-under-test is a third analog-to-digital converter.

52. A system suitable use in identifying a noise component originating from a device under test in a DSP-based mixed-signal system, said system comprising:
a. a test module including:
i. an input suitable for receiving a test signal;
ii. a first output suitable for releasing a first signal;
iii. a second output for releasing a second signal;
iv. a third output for releasing a third signal;
v. a first signal path between said input and said first output including a digital-to-analog converter and a first analog-to-digital converter;
vi. a second signal path between said input and said second output including the digital-to-analog converter and a second analog-to-digital converter;
vii. a third signal path between said input and said third output including the digital-to-analog converter and a device-under-test;
b. a processing unit adapted for processing the first signal, the second signal and the third signal to derive a noise component associated to the device-under-test;
c. an output for releasing the noise component associated to the device-under-test.

53. A system as defined in claim 52, wherein the device-under-test is a third analog-to-digital converter.

54. An apparatus suitable for use in identifying a noise component originating from a certain source of noise in a DSP-based mixed-signal system, said apparatus comprising:
a. a processing unit operative for:
i. receiving a first signal released by a first signal path, the first signal path including a primary component and a secondary component;
ii. receiving a second signal released by a second signal path, the second signal path including the primary component and a third component distinct from the secondary component;
iii. processing said first signal to derive a first frequency domain signal;
iv. processing the first frequency domain signal to derive a first noise component associated with the first signal;
v. processing said second signal to derive a second frequency domain signal;
vi. processing the second frequency domain signal to derive a second noise component associated with the second signal;
vii. processing the first frequency domain signal and the second frequency domain signal to derive a third noise component, the third noise component being indicative of a noise component associated with a certain source of noise, the certain source of noise being a selected one of the primary component, the secondary component and the third component;
b. an output for releasing a signal indicative of the noise component associated to the certain source of noise.

55. An apparatus as defined in claim 54, wherein the primary component is a digital-to-analog converter and the secondary component is a first analog-to-digital converter and the third component is a second analog-to-digital converter.

56. An apparatus as defined in claim 54, wherein the primary component is an analog-to-digital converter and the second component is a first digital-to-analog converter and the third component is a second digital-to-analog converter.

57. An apparatus suitable for use in identifying a noise component originating from a certain source of noise in a DSP-based mixed-signal system, said apparatus comprising:
a. means for receiving a first signal released by a first signal path, the first signal path including a digital-to-analog converter and a first analog-to-digital converter;
b. means for receiving a second signal released by a second signal path, the second signal path including the digital-to-analog converter and a second analog-to-digital converter;
c. means for processing said first signal to derive a first frequency domain signal;
d. means for processing the first frequency domain signal to derive a first noise component associated with the first signal;
e. means for processing said second signal to derive a second frequency domain signal;
f. means for processing the second frequency domain signal to derive a second noise component associated with the second signal;
g. means for processing the first frequency domain signal and the second frequency domain signal to derive a third noise component, the third noise component being indicative of a noise component associated with a certain source of noise, the certain source of noise being a selected one of the digital-to-analog converter, the first analog-to-digital converter and the second analog-to-digital converter;
h. means for releasing a signal indicative of the noise component associated to the certain source of noise.
